(19) United States
(12) Patent Application Publication
(10) Pub. No.: US 2025/0233750 A1
(43) Pub. Date: Jul. 17, 2025

(54) DATA ASSET IDENTIFIER GENERATION SYSTEM

(71) Applicant: SpyCloud, Inc., Austin, TX (US)

(72) Inventors: Trevor Hilligoss, Austin, TX (US); Nathan Shin, Austin, TX (US); Rubin Ridley, Austin, TX (US)

(21) Appl. No.: 19/019,425

(22) Filed: Jan. 13, 2025

Related U.S. Application Data
(60) Provisional application No. 63/620,728, filed on Jan. 12, 2024.

(51) Int. Cl. H04L 9/32

(52) U.S. Cl. CPC H04L 9/3239

(57) ABSTRACT

A process that includes individually hashing, according to a first hashing algorithm, each file of a first plurality of files included in a first data asset to obtain a first plurality of hash values. The process includes sorting, according to a sorting algorithm, each hash value of the first plurality of hash values in a first ordered list of hash values and concatenating the first plurality of hash values in the first ordered list of hash values to generate a first string. The process further includes hashing, according to a second hashing algorithm, the first string to generate a first data asset identifier representing the first data asset and storing the first data asset identifier in a security database.

### CROSS-REFERENCE TO RELATED APPLICATIONS

This patent application claims benefit of U.S. Provisional Patent Application 63/620,728, titled “DATA ASSET IDENTIFIER GENERATION SYSTEM,” filed 12 Jan. 2024. The entire content of each aforementioned patent filing is hereby incorporated by reference.

### BACKGROUND

### 1. Field

The present disclosure relates generally to cybersecurity and, more specifically, to generating a data asset identifier for a data asset having a plurality of files.

### 2. Description of the Related Art

Computer-security professionals are losing the battle to prevent use of stolen or otherwise exposed security credentials, such as passwords, by which users are authenticated by computer networks. In part, this is due to poor, prevalent password hygiene. People tend to reuse passwords or use low-entropy variations. And these passwords (a term used generically herein to refer to knowledge-factor and biometric security credentials), along with associated user identification, can be easily exposed or stolen, which can help threat actors access various sensitive accounts related to a user. A report by Verizon™ in 2017 indicated that 81% of hacking-related breaches leveraged either stolen or weak passwords and in July 2017 Forrester™ estimated that account takeovers would cause at least $6.5 billion to $7 billion in annual financial losses across industries. Other attack vectors include brute force attacks. Modern GPU's and data structures like rainbow tables facilitate password cracking at rates that were not contemplated when many security practices were engineered. Still other attack vectors include malware captured session cookies and credentials that may allow malicious actors to impersonate a legitimate user. Malicious actors can sell resulting tested credentials on the dark web, making it relatively easy to monetize user credentials and incentivizing even more password cracking. Various malicious buyers of this information may use password and user identification combinations in order to breach and retrieve highly confidential information.

To impede these attacks, online services like “Have I Been Pwned” have arisen. Such systems maintain a database of breached credentials and expose an interface by which the records may be interrogated by users seeking to determine if their credentials have been compromised. Such systems, however, are often too rarely accessed, particularly in the context of enterprise networks, where highly valuable information can be exfiltrated relatively quickly after credentials are compromised. And responses to detected threats are often not fully implemented, as propagating appropriate changes throughout an enterprise network can be relatively high-latency and complex.

### SUMMARY

Accordingly, there is a need to generate a data asset identifier for a data asset having a plurality of files obtained from malicious sources to more efficiently determine redundant data assets for storage and processing considerations, differences in a data asset over time, or other uses.

The following is a non-exhaustive listing of some aspects of the present techniques. These and other aspects are described in the following disclosure.

Some aspects include a process, including: individually hashing, by a computer system and according to a first hashing algorithm, each file of a first plurality of files included in a first data asset to obtain a first plurality of hash values; sorting, by the computer system and according to a sorting algorithm, each hash value of the first plurality of hash values in a first ordered list of hash values; concatenating, by the computer system, the first plurality of hash values in the first ordered list of hash values to generate a first string; hashing, by the computer system and according to a second hashing algorithm, the first string to generate a first data asset identifier representing the first data asset; and storing, by the computer system, the first data asset identifier in a security database.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a logical and physical architecture block diagram showing an example system for facilitating data asset identifier generation of a data asset including a plurality of files, in accordance with some embodiments of the present disclosure;

FIG. 1B is a logical and physical architecture block diagram showing another example system for facilitating data asset identifier generation of a data asset including a plurality of files, in accordance with some embodiments of the present disclosure;

FIG. 2 is a flow chart that illustrates an example process of populating a database suitable for use in the system of FIG. 1A or 1B, in accordance with some embodiments of the present disclosure;

FIG. 3 is a flowchart describing an example of a process of cleansing collected data, in accordance with some embodiments of the present disclosure;

FIG. 4 is a flowchart of an example process that facilitates data asset identifier generation of a data asset including a plurality of files, in accordance with some embodiments of the present disclosure; and

FIG. 5 is an example of a computing device by which the above techniques may be implemented.

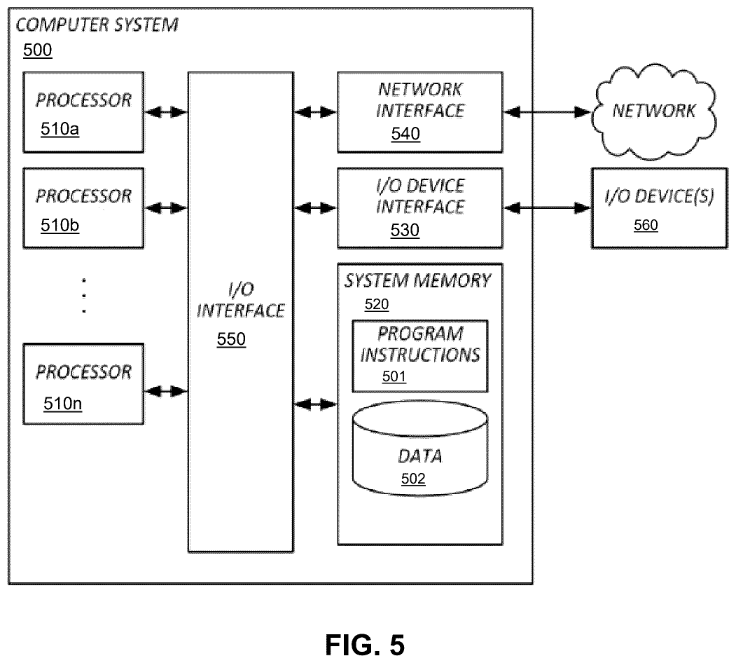

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of cybersecurity and data asset management. Indeed, the inventors wish to emphasize the difficulty of recognizing those problems that are nascent and will become much more apparent in the future should trends in industry continue as the inventors expect. Further, it should be understood that some embodiments are problem-specific, and not all embodiments address every problem with traditional systems described herein or provide every benefit described herein. That said, improvements that solve various permutations of these problems are described below. Some aspects of the present techniques may be described below under different headings in all-caps. These techniques may be used together or independently (along with the description above), which is not to suggest that other descriptions are limiting.

Online fraud threats have skyrocketed in recent years, with losses now predicted to exceed $206 billion by 2025. As fraud increases in both prevalence and sophistication, even enterprises with strong fraud prevention programs struggle to confidently distinguish real consumers from cybercriminals. Businesses are missing a crucial element in their control frameworks: visibility of stolen information that enables criminals to evade detection and perpetrate account takeover, identity fraud, and new account fraud. Specifically, malware-stolen data often results in fraud. Malware bot logs may provide malicious actors with the information they need to impersonate a website's users and sidestep anti-fraud measures like multi-factor authentication. Logs or other data assets siphoned from malware may include authentication data, like credentials or cookies, as well as system data that a malicious actor may use to fool anti-fraud solutions. Criminals can use these logs to commit several kinds of fraud such as, for example, account takeover, synthetic identities, card not present fraud, identity theft, triangulation fraud, and other malicious activity.

These logs or other data assets may often be published on nefarious websites, on repositories on the dark web, or otherwise made available to criminals. Cybersecurity companies can gather and obtain these data assets from the various sources and use them to identify users of customers that may have been compromised. The cybersecurity companies may then alert customers of users that may be compromised to mitigate criminal activities or perform other mitigating actions based on the captured data assets. However, the number of data assets retrieved and processed can be in the millions or billions and can be retrieved from numerous sources. As such, duplicates of data assets can be retrieved. This becomes a burden on the cybersecurity companies' computing resources such as storage and processing resources when identifying compromised users. Conventional comparisons of data assets to remove duplicate data asset files from the repository of captured data assets is computationally expensive as the system must compare the entire file content of a data asset to the file content of other data assets. Furthermore, conventional comparisons are inaccurate because files may be stored in a data asset in different orders which causes otherwise duplicate data assets to be determined as different or non-duplicate data assets.

The systems and methods of the present disclosure mitigate some of the above-described issues (or other problems described below or that will be self-evident to those in the field) by generating a data asset identifier for each data asset. A data asset identifier engine may hash each file in the data asset based on the content of the file to obtain a hash value. The resulting hash value may be appended to a list, and the data asset identifier engine may sort the hash values in the list to obtain a sorted hash value list. The data asset identifier engine may then concatenate the hash values of the files into a string, and the data asset identifier engine performs a second hashing on that string to result in a hash value of the string. That hash value, a hexadecimal representation of the hash value, or other representation of the hash value may be the resulting data asset identifier.

Once the data asset identifiers are obtained, the data asset identifier engine may determine hash collisions of the data asset identifiers. Data assets, whose data asset identifier has a hash collision, may be removed so that only a single copy remains on the system. The data asset identifier engine may track the number of collisions that each data asset identifier has and the sources of the data asset from which each data asset was obtained.

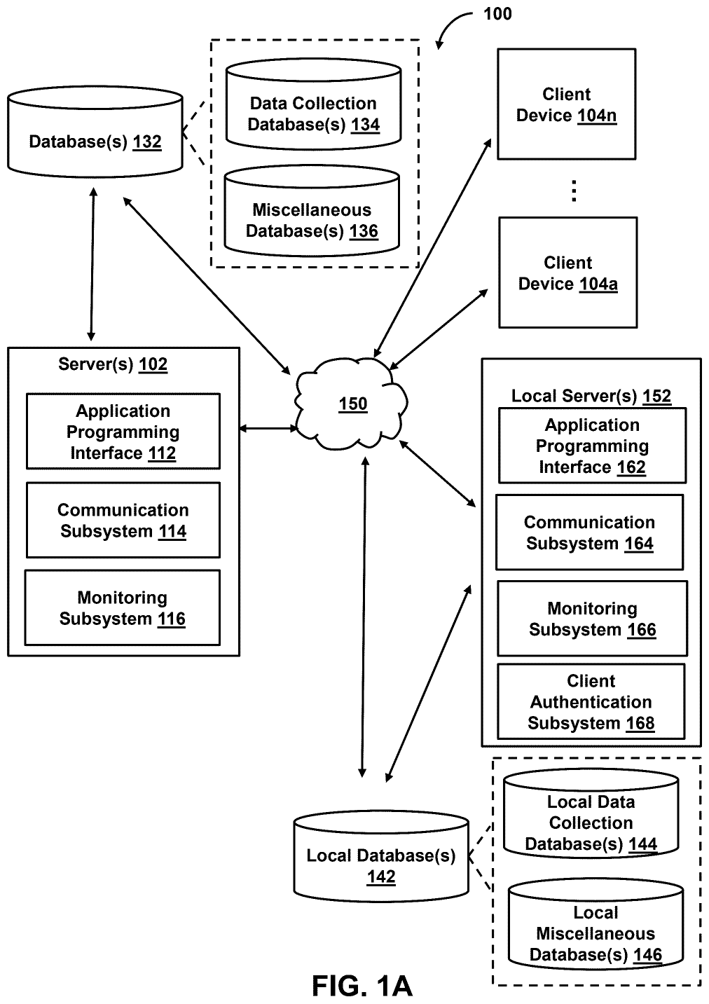

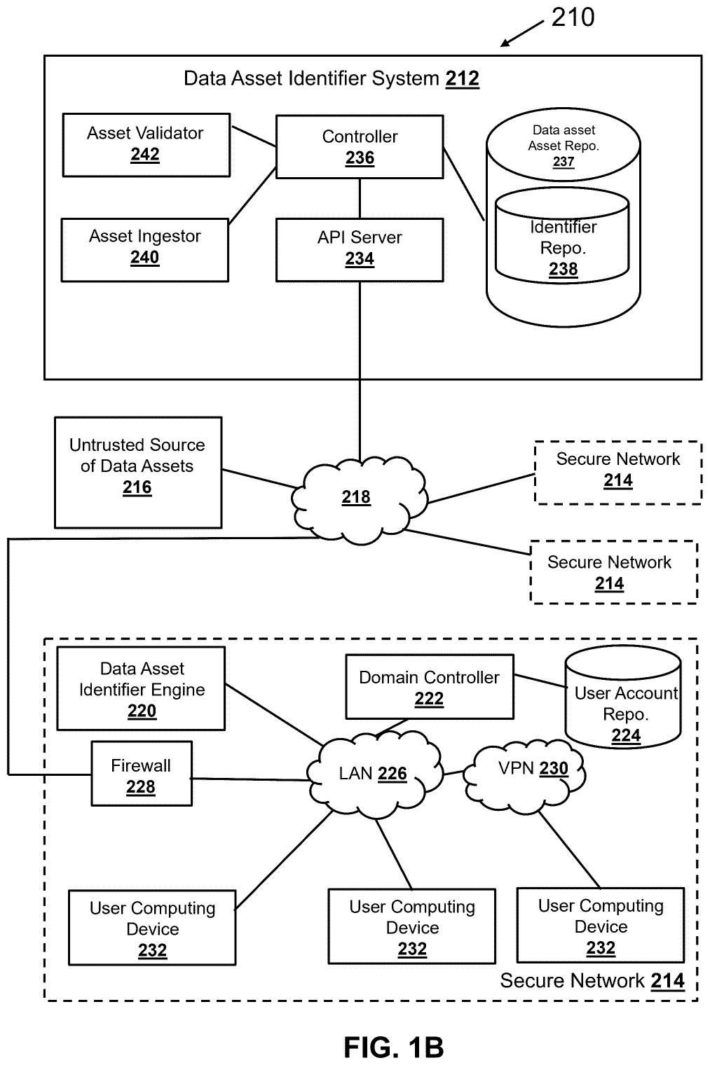

FIG. 1A illustrates a computing environment 100 having components configured to generate an identifier for a data asset such as a malware log that includes a plurality of data files, folders, or other data assets having a plurality of files. As illustrated in FIG. 1A, computing environment 100 may include servers 102, client devices 104a-104n, databases 132, local databases 142, and local servers 152. Server 102 may expose an application programming interface (API) 112 and include a communication subsystem 114 and a monitoring subsystem 116. The monitoring subsystem 116 may include a data asset identifier engine that may perform the functionalities of the data asset identifier engine or servers 102 discussed in more detail below (e.g., hashing files within a data asset (e.g., a log), appending the hash values of each file to a list, sorting the hash values, concatenating the sorted hash values into a string, and hashing the string to obtain a hash value of the string to generate a data asset identifier). Local server 152 may expose an API 162 and include a communication subsystem 164, a monitoring subsystem 166, a client authentication subsystem 168, or other components (which is not to suggest that other lists are limiting). In some embodiments, the monitoring subsystem 166 may perform security actions based on received data assets.

Three client devices are shown, but commercial implementations are expected to include substantially more, e.g., more than 100, more than 1,000, or more than 10,000. Each client device 104 may include various types of mobile terminal, fixed terminal, or other device. By way of example, client device 104 may include a desktop computer, a notebook computer, a tablet computer, a smartphone, a wearable device, or other client device. Users may, for instance, use one or more client devices 104 to interact with one another, one or more servers, or other components of computing environment 100. It should be noted that, while one or more operations are described herein as being performed by particular components of server 102 or local server 152, those operations may, in some embodiments, be performed by other components of server 102, local server 152, or other components of computing environment 100. As an example, while one or more operations are described herein as being performed by components of server 102 or local server 152, those operations may, in some embodiments, be performed by components of client device 104. Further, although the database 132 and local database 142 are illustrated as being separate from the server 102, local server 152, and the client device 104, the database 132 and the local database 142 may be located within the client device 104, server 102, or local server 152.

FIG. 1B is a logical and physical architecture block diagram showing another example of a computing environment 210 having a data asset identifier system 212 and a data asset identifier engine 220 configured to mitigate some of the above-described problems. In some embodiments, the computing environment 210 is, in some aspects, a more specific version of that described above in FIG. 1A. In some embodiments, the computing environment 210 includes the data asset identifier system 212, a plurality of different secure networks 214, an untrusted source of data assets 216, and a public network, like the Internet 218.

Three secure networks 214 are shown, though embodiments are consistent with substantially more. In some embodiments, each secure network 214 may correspond to a different secure network of a different tenant account subscribing to services from the data asset identifier system 212, for example, in a software as a service offering, or some embodiments may replicate some or all of the data asset identifier system 212 on-premises. In some embodiments, each of the secure networks 214 may define a different secure network domain in which authentication and authorization determinations are independently made, for instance, a user authenticated on one of the secure networks 214 may not be afforded any privileges on the other secure networks 214 in virtue of the authentication. In some cases, each secure network 214 may be a different enterprise network, for instance, on a private subnet hosted by a business or other organization.

In some embodiments, the secure network 214 may include the above-noted data asset identifier engine 220, a domain controller 222, a user account repository 224, a private local area network 226, a firewall 228, a virtual private network connection 230, various user computing devices 232, and in some cases various network-accessible resources hosted within the secure network for which access is selectively granted by the domain controller 222 responsive to authorization and authentication determinations based on user credentials. Generally, authentication is based on confirming the identity of an entity, and authorization is based on whether that entity is permitted to access resources in virtue of being authenticated. In some embodiments, the user computing devices 232 may be physically co-located, or some user computing devices may be remote, for instance, those connecting via a virtual-private network (VPN) connection 230. Three user computing devices 232 are shown, but commercial implementations are expected to include substantially more, and in some cases with substantially more remote computing devices connecting via a plurality of different VPN connections. In some embodiments, the local area network 226 may be addressed by a range of private Internet Protocol addresses assigned to the various illustrated computing devices, and in some cases, those same private Internet Protocol addresses may be used on other secure networks 214, for instance, behind a network address translation table implemented by the firewall 228 or a router.

In some embodiments, the domain controller 222 is an Active Directory™ domain controller or other identity management service configured to determine whether to service authentication requests from user computing devices 232 or other network resources (e.g., computing devices hosting services to which the user computing devices 232 seek access). In some embodiments, the domain controller 222 may receive requests including a username and one or more security factors, like a knowledge factor credential, such as a password, a pin code, or in some cases, a value indicative of a biometric measurement. The terms “password” and “credential” refer both to the plain-text version of these values and cryptographically secure values based thereon by which possession of the plain-text version is demonstrated, e.g., a cryptographic hash value or ciphertext based on a password. Thus, in some embodiments, these inputs may be received in plain-text form, or cryptographic hash values based thereon, for instance, calculated by inputting one of these values and a salt value into a SHA 256 cryptographic hash function or the like, may serve as a proxy.

In some embodiments, the domain controller 222 may respond to authentication requests by retrieving a user account record from the repository 224 corresponding to the username (a term which is used to refer broadly to refer to values, distinct from knowledge-factor credentials, by which different users are distinguished in a username space, and which may include pseudonymous identifiers, email-addresses, and the like) in association with the request. In some embodiments, in response to the request, the domain controller 222 may determine whether a user account associated with the username (e.g., uniquely associated) indicates that the user account has a valid set of credentials associated therewith, for instance, that a password has been registered and has not been designated as deactivated, e.g., by setting a flag to that effect in the account to deactivate a previously compromised (e.g., breached, phished, or brute forced) password. In response to determining that the user account does not have a valid set of credentials associated therewith, some embodiments may respond to the requests by denying the request, and supplying instructions to populate a user interface by which new credentials may be registered and stored in the user account.

In some embodiments, in response to determining that the user account has valid credentials, the domain controller 222 may then determine whether the credentials associated with the request for authentication match those in the user account record, for instance, whether the user demonstrated possession of a password associated with the username in the user account. Possession may be demonstrated by supplying the password in plain text form or supplying a cryptographic hash thereof. In some embodiments, passwords are not stored in plaintext form in the user account repository and cryptographic hashes of passwords in the user account are compared to cryptographic hashes of user input credentials to determine whether the user has demonstrated possession of the password. In response to determining that the credentials associated with the request do not match those in the user account, in some embodiments, the domain controller 222 may respond to the request by transmitting a signal indicating that the request is denied to the requesting user computing device 232.

In some embodiments, in response to determining that the credentials supplied with the request match those in the user account, some embodiments may respond to the request by authenticating the user and, in some cases, authorizing (or causing other services to authorize) various forms of access to network resources on the secure network, including access to email accounts, document repositories, network attached storage devices, and various other network-accessible services accessible (e.g., exclusively) on the secure network 214 (e.g., selectively based on the requestor's identity). As described herein, such workflows may be referred to as a user interaction cycle that may include a plurality of user interaction points (e.g., authenticating a user, changing user settings or information, completing purchases, user account creation, or other sensitive interaction points with an enterprise or application. In some embodiments, upon authentication, various computing devices on the secure network 214 may indicate to one another that they are authorized to access resources on one another or otherwise communicate, e.g., with the Kerberos security protocol, such as the implementation described in RFC 3244 and RFC 4757, the contents of which are hereby incorporated for by reference. As discussed above, in some embodiments, the domain controller 222 may require a multi-factor authentication (MFA). Once a user of a user computing device 232 completes the MFA, a session may be initiated and stored in the user account repository and a session cookie such as a device cookie may be stored on the user computing device 232. By creating the session, the user of the user computing device 232 does not have to complete the MFA for a time period (e.g., an hour, a day, two days a week, two weeks, a month, two months, or any other time period.

In some embodiments, the data asset identifier engine 220 and the data asset identifier system 212 may be co-located on the same secure network 214, or in some cases portions may be implemented as a software as a service model in which the same data asset identifier system 212 is accessed by a plurality of different secure networks 214 hosted by a plurality of different tenants. The data asset identifier engine 220 and the data asset identifier system 212 collectively form an example of a distributed application that is referred to as a distributed data asset management application. Other examples of such an application are described with reference to FIG. 1A. The components are described as services in a service-oriented architecture (e.g., where different functional blocks are executed on different network hosts (or collections thereof) and functionality is invoked via network messages). But embodiments are consistent with other design patterns, e.g., the data asset identifier engine 220 and the domain controller 222 may be integrated in the same host or process, the data asset identifier engine 220 may operate as an agent on each of the user computing devices, or the data asset identifier engine 220, the domain controller 222, and the data asset identifier system 212 may be integrated on a single host or process.

In some embodiments, the data asset identifier system 212 may include an application program interface server 234, such as a nonblocking server monitoring a network socket for API requests and implementing promises, callbacks, deferreds, or the like. In some embodiments, the controller 236 may implement the processes described herein by which user information is obtained, and in some cases cracked, validated, stored, and interrogated. In some embodiments, at the direction of the controller 236, for instance responsive to commands received via the API server 234, data assets such as user information assets stored in a data asset repository 237 may be interrogated to return an updated full set, or result of comparison to user information determined to have been potentially compromised or indicating fraudulent behavior with the techniques described herein. The data asset repository 237 may include a data asset identifier repository 238. In some embodiments, the controller 236 is further configured to ingest data assets such as user information assets with an asset ingestor 240 from various remote sources, such as an untrusted source of data assets 216 via the Internet 218. Examples of sources of user information assets are described below and include various repositories on the dark web. In some embodiments, received user information assets may undergo various types of processing with the information asset validator 242, for instance, de-duplicate user information with those previously determined to have been retained, cracking credentials published in encrypted form, mapping user identifiers, or associating credentials with other user identifiers. Results may be stored in the data asset repository 237 and in some cases, one or more of the above-described data structures by which user information assets are compared with those in the user account repository 224 may be updated.

The systems of FIGS. 1A and 1B may execute various processes like those described below, though the following processes are not limited by the above implementations, which is not to suggest that any other description herein is limiting. It should be noted that the various processes executed by one or more components of the secure network 214 in FIG. 1B may be executed by one or more of local server 152, client device 104, and local database 142 in FIG. 1A (or vice versa), and the various processes executed by one or more components of the data asset identifier system 212 in FIG. 1B may be executed by one or more of server 102 and database 132 in FIG. 1A (or vice versa). In other words, the above or below discussed processes executed by one or more components of the computing environment 210 may be executed by one or more components of the computing environment 100 (or vice versa).

### Obtaining Logs and Other Data Assets

Various approaches may be executed to data assets, user information assets, or portions thereof and other user information assets such as compromised (e.g., breached, brute forced, or phished) confidential information, like compromised credentials, leaked personally identifiable information (like social security numbers), passkey information or other FIDO and WebAuthn security standard based security information that may be used to bypass a passkey authentication. or financial credentials like account numbers, for purposes of detecting that the information has been compromised. In some examples, malware accessing memory could compromise a passkey, as well as the passkey itself. The database 132 and local database 142 illustrated in FIG. 1A or the data asset repository 237 of FIG. 1B may be populated by collecting data from a plurality of sources and using a plurality of data collection techniques. Although a data asset repository 237 and a data asset identifier repository 238 is illustrated in FIG. 1B as being part of a data asset identifier system 212. Data corresponding to leaked or stolen user information assets (including user credentials) may be collected using multiple techniques and from many sources. Some of the techniques for collecting leaked or stolen user information assets include (a) human intelligence (HUMINT) and applied research (HUMINT+TECHNOLOGY) and (b) scanners and automatic collection tools. HUMINT is an information gathering technique that uses human sources, and may include such a human source acquiring a copy of a set of compromised credentials from the dark web. Both the techniques noted above may be implemented in some cases. Although the scanners and automatic collection tools may be relatively efficient at collecting information from the regular web, manual techniques may be needed in some use cases to collect leaked or stolen assets from the deep or dark web, which is not to suggest that purely automated approaches or any other technique is disclaimed.

The above noted techniques, alone or in combination, collect data from several sources. These sources include, but are not limited to (which is not to imply other lists are limiting), private sources, covert sources, active account takeover (ATO) combination lists, stolen assets, infected users, open sources, private forums, dark web markets, tor hidden services, and pastes. Once the data is collected, the data may be cleansed by putting the collected data through a rigorous quality-control process to determine the value of the collected data. After the data is cleansed, a database may be populated based on the cleaned data.

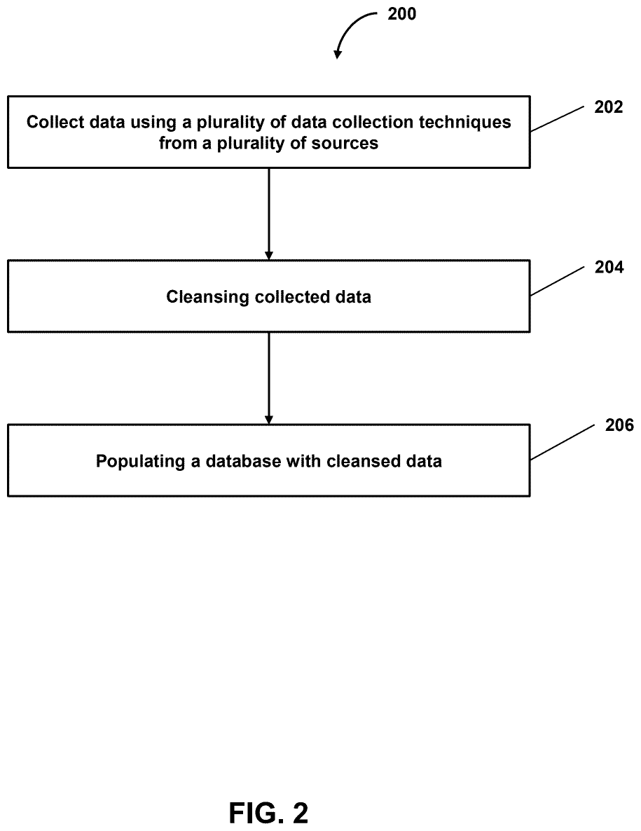

FIG. 2 illustrates an example process 200 of obtaining data assets like logs or other user information assets. The process 200, like the other processes described herein, may be implemented by executing instructions stored on a tangible, machine-readable medium with one or more processors, in some cases, with different processors executing different subsets of the instructions and with different physical memory or computing devices storing different subsets of the instructions. The processes (which includes the described functionality) herein may be executed in a different order from that depicted, operations may be added, operations may be omitted, operations may be executed serially, or operations may be executed concurrently, none of which is to suggest that any other description is limiting. In some embodiments, the processes herein may be implemented in one or more processors (e.g., a term which refers to physical computing components, like a central processing unit, a GPU, a field-programmable gate array, application-specific integrated circuits, and combinations thereof). The processing devices may include one or more devices executing some or all of the operations of the method in response to instructions stored on an electronic, magnetic, or optical storage medium.

In step 202, in some embodiments, data (for example, exposed or stolen data related to personally identifiable information) may be collected using a plurality of data collection techniques from a plurality of sources. In some examples, the data may include data stolen by malware or other malicious programs where that data is included in malware logs or other data assets.

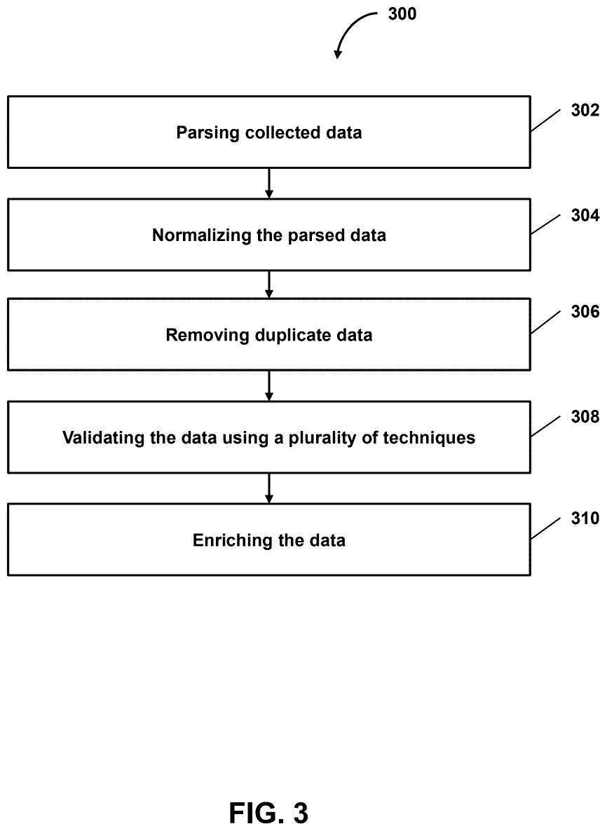

After the data is collected, in step 204, the collected data may be cleansed by putting the data through a rigorous quality-control process to determine the value of the collected data. The cleansing of the collected data may include several steps (examples of which are discussed in more detail below with reference to FIG. 3). The cleansing steps include parsing, normalizing, removing duplicates, validating, and enriching. Once the data is cleansed, in step 206, a database may be populated with the cleansed data. This data may then be used to efficiently retrieve user information assets that include logs that may include cookies associated with a domain as well as user information associated with a device or user account associated with the exposed cookie. The data may also be used to efficiently retrieve other compromised sensitive or confidential information related to the user.

FIG. 3 illustrates an example process 300 of cleansing collected data described in step 204 in FIG. 2. In step 302, in some embodiments, the collected data is parsed, and the parsed data is normalized in step 304. During the normalization process, in some embodiments, the data is parsed and classified into different fields (e.g., a date of birth, a username, a password, a domain name, an identification (e.g., a social security number, a driver's license number, a passport number, or the like), an email, a phone number, a name, a street address, malware logs, cookies, or other fields that would be apparent to one of skill in the art in possession of the present disclosure). Also, during the normalization process (or during any step illustrated in FIG. 3), data that is not relevant may be deleted. For example, data records that do not include passwords or high value personal identification information may be discarded.

In step 306, duplicate data may be removed. During this step, in some embodiments, the normalized data may be compared to more than one or ten billion assets already stored in the database 132 (for example, the data collection database 134) or local database 142 (for example, the data collection database 144) and data that are duplicates may be discarded. In some cases, the above techniques configured to expedite pairwise matching of sets may be implemented to perform deduplication. Although duplicate data may be discarded, the database 132 or local database 142 may keep a record of a number of duplicates that were retrieved from unique sources.

In step 308, the data may be then validated using a plurality of techniques. Routines such as “validation rules, “validation constraints,” or “check routines” may be used to validate the data so as to check for correctness and meaningfulness. The rules may be implemented through the automated facilities of a data dictionary, or by the inclusion of explicit application program validation logic.

Finally, in step 310, the data may be enriched so that the database 132 (for example, the data collection database 134) or local database 142 (for example, the data collection database 144) may be populated with, for example, how many times user credentials have been ingested from a unique source, the severity of each individual record, and additional metadata combined from different sources.

The populated database 132 (for example, the data collection database 134 or repository 238) or the local database 142 (for example, the data collection database 144) may take a number of forms, including in memory or persistent data structures, like ordered/unordered flat files, Indexed Sequential Access Method (ISAM), heap files, hash buckets, or B+trees. In some embodiments, the data may be relatively frequently (e.g., more than once a week on average) collected, cleansed, and populated.

### Generation of Data Asset Identifier for Data Asset

With respect to step 306 of process 300 and discussed above, identifying and removing duplicate data is time consuming and a computer processing intensive process. Pairwise matching is inaccurate and time consuming when comparing a data asset to potentially billions of other data assets. When a data asset includes a plurality of files, the ordering of those files may cause otherwise identical user information assets to be identified as non-duplicative.

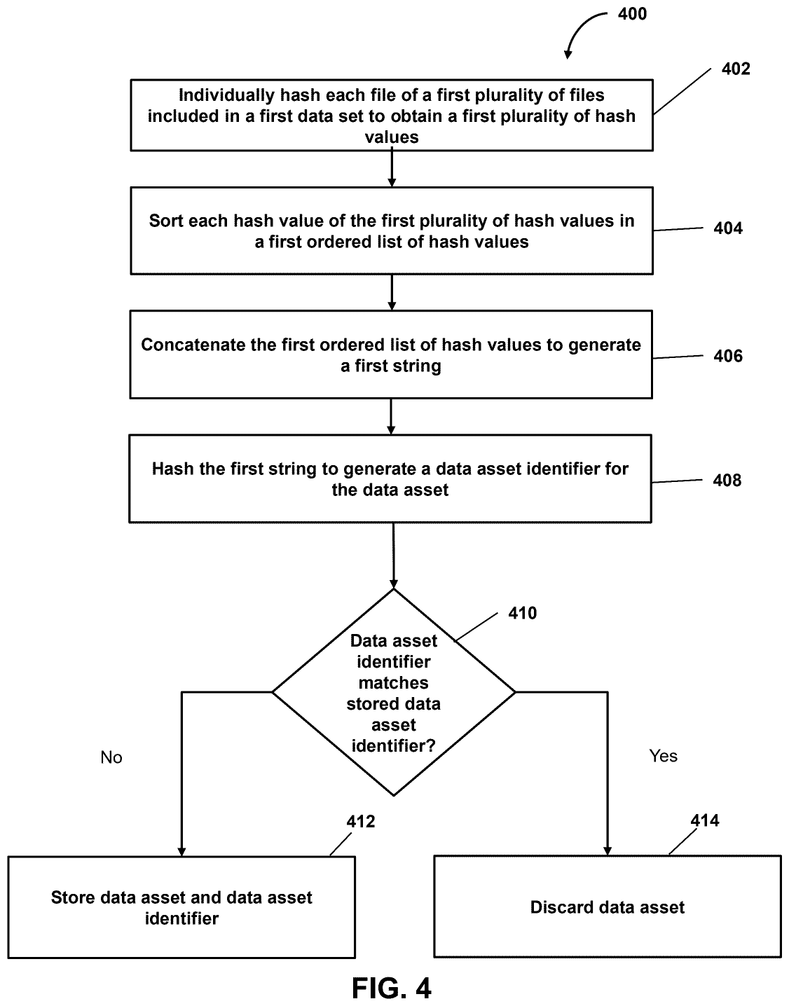

Systems and methods of the present disclosure create a data asset identifier for data assets. FIG. 4 illustrates an example process 400 of data asset identifier generation or removal of duplicate data assets as one or more separate step of process 300 or incorporated into one or more of steps 302-306 to improve removal of duplicate data. In step 402, each file of a first plurality of files included in a first user information asset are individually hashed using a hashing algorithm to obtain a first plurality of hash values. The data asset identifier system 212 may obtain a data asset according to process 200 above and may perform a hashing operation on each of the files included in the data asset. The hashing operation may be performed on the raw data asset, the parsed data asset after step 302, the normalized data asset after step 304, removing duplicate data (e.g., duplicate data within a data set itself) or at any other time during the data asset intake process. These files of the data asset may be received in plain-text form and transformed into cryptographic hash values, for instance, calculated by inputting one of the files and a salt value into a secure hash algorithm (SHA) (e.g., SHA-256) or other hashing algorithm.

The process 400 may proceed to step 404 where each hash value of the first plurality of hash values is sorted, according to a sorting algorithm, in a first ordered list of hash values. The data asset identifier system 212 may provide the hash values of each file or a hexadecimal representation thereof into a list. A sorting algorithm may operate on the list to place the resulting hash values in an alphanumeric order or other sorting scheme that would be apparent to one of skill in the art in possession of the present disclosure.

The process 400 may proceed to step 406 where the first plurality of hash values are concatenated to generate a string. The data asset identifier system 212 may concatenate the ordered list of hash values representing each file in the data asset into a string. The process 400 may proceed to step 408 where the string is hashed, according to a hashing algorithm, to generate a first data asset identifier representing the first data asset. The hashing algorithm may be the same hashing algorithm or a different hashing algorithm than what was used to hash each of the files included in the data asset. The resulting hash value, a hexadecimal representation of the hash value, or other representation of the hash value may be the data asset identifier.

The process 400 may proceed to decision step 410 where it is determined whether the identifier matches other identifiers stored in the security database. The data asset identifier system 212 may determine whether the resulting identifier matches any other data asset identifier in the data asset identifier repository. The data asset identifier system 212 may perform pairwise matching of the generated data asset identifier and the stored data asset identifiers. Performing the pairwise matching of the data asset identifiers is less process intensive than performing the pairwise matching of each data asset and its files to the stored data assets and their files and reduces false negatives.

If at decision step 410 there is no match of the generated data asset identifier to the stored data asset identifiers, the process 400 may proceed to step 412 where the data asset is stored in the data asset repository 237 and the generated data asset identifier is stored in the data asset identifier repository 238. If, at decision step 410, there is a hash collision, the duplicate data asset may be removed at step 414. Although duplicate data may be discarded, the database 132, local database 142, data asset repository 237, or data asset identifier repository 238 may keep a record of a number of duplicates that were retrieved from unique sources. As such, the data asset identifier system 212 may determine that a second source of the second data asset is different than a first source of the first data asset and log the second source with the first source in a data asset tracking library when the first data asset and the second data asset are the same. Another result of reducing false negatives of non-matches between otherwise duplicate data assets is the reduction of alerts to the client or user associated with the data asset. When duplicate data is found, user alerts may not be generated and sent to the client, customer, or user that is associated with the data asset. Otherwise, a user alert may be provided to the user(s) or domain(s) associated with the data asset. In other examples, a customer query may result in fewer data assets that are returned to the customer due to less false negative matches.

Thus, systems and methods of the present disclosure provide an efficient process for determining duplicate data assets when building a data asset database and particularly building a log database of malware logs for cybersecurity purposes. By hashing individual files within a data asset, sorting the resulting hash values, concatenating those ordered hash values into a string, and performing a subsequent hashing operation on the string to obtain a data asset identifier, the systems and methods of the present disclosure can use that data asset identifier to search for already existing data asset identifiers stored in a data asset repository and discard any duplicates while storing any data assets where its data asset identifier does not collide with the stored data asset identifiers. As such, improvements to cybersecurity and data storage and management is achieved by reducing storage requirements of data assets and reducing false negatives when pairwise comparisons determine there is not a match between data assets due to the ordering of files and non-normalized files resulting in mismatches even thought the data assets include the same data.

FIG. 6 is a diagram that illustrates an exemplary computing device 600 in accordance with embodiments of the present technique. Various portions of systems and methods described herein may include or be executed on one or more computer systems similar to computing device 600. Further, processes and modules described herein may be executed by one or more processing systems similar to that of computing device 600.

Computing device 600 may include one or more processors (e.g., processors 610a-610n) coupled to system memory 620, an input/output I/O device interface 630, and a network interface 640 via an input/output (I/O) interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing device 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing device 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing device 600 may include a plurality of computing devices (e.g., distributed computer systems) to implement various processing functions.

I/O device interface 630 may provide an interface for connection of one or more I/O devices 660 to computing device 600. I/O devices may include devices that receive input (e.g., from a user) or output information (e.g., to a user). I/O devices 660 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing device 600 through a wired or wireless connection. I/O devices 660 may be connected to computing device 600 from a remote location. I/O devices 660 located on remote computer system, for example, may be connected to computing device 600 via a network and network interface 640.

Network interface 640 may include a network adapter that provides for connection of computing device 600 to a network. Network interface 640 may facilitate data exchange between computing device 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 601 or data 602. Program instructions 601 may be executable by a processor (e.g., one or more of processors 610a-610n) to implement one or more embodiments of the present techniques. Instructions 601 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 620 may include a non-transitory computer readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing device 600 or multiple computing device 600 configured to host different portions or instances of embodiments. Multiple computing devices 600 may provide for parallel or sequential processing/execution of one or more portions of the techniques described herein.

Those skilled in the art will appreciate that computing device 600 is merely illustrative and is not intended to limit the scope of the techniques described herein. Computing device 600 may include any combination of devices or software that may perform or otherwise provide for the performance of the techniques described herein. For example, computing device 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing device 600 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing device 600 may be transmitted to computing device 600 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A non-transitory, machine-readable medium storing instructions that, when executed by one or more processors, effectuate operations comprising: individually hashing, by a computer system and according to a first hashing algorithm, each file of a first plurality of files included in a first data asset to obtain a first plurality of hash values; sorting, by the computer system and according to a sorting algorithm, each hash value of the first plurality of hash values in a first ordered list of hash values; concatenating, by the computer system, the first plurality of hash values in the first ordered list of hash values to generate a first string; hashing, by the computer system and according to a second hashing algorithm, the first string to generate a first data asset identifier representing the first data asset; and storing, by the computer system, the first data asset identifier in a security database.
2. The medium of embodiment 1, wherein the operations further comprise: storing, by the computer system, the first data asset in the security database.
3. The medium of any one embodiments 1-2, wherein the operations further comprise: individually hashing, by the computer system and according to the first hashing algorithm, each file of a second plurality of files included in a second data asset to obtain a second plurality of hash values; sorting, by the computer system and according to the sorting algorithm, each hash value of the second plurality of hash values in a second ordered list of hash values; concatenating, by the computer system, the second plurality of hash values to generate a second string; hashing, by the computer system and according to the second hashing algorithm, the second string to generate a second data asset identifier representing the second data asset; and comparing, by the computer system, the first data asset identifier to the second data asset identifier to determine whether a hash collision has occurred.
4. The medium of embodiment 3, wherein the operations further comprise: discarding, by the computer system, the second data asset if a hash collision occurred.
5. The medium of embodiment 4, wherein the operations further comprise: determining, by the computer system, that a second source of the second data asset is different than a first source of the first data asset; and logging, by the computer system, the second source with the first source in a data asset tracking library.
6. The medium of embodiment 3, wherein the operations further comprise: not providing, by the computer system, an alert of the second data asset to a user associated with the second data asset if a hash collision occurred.
7. The medium of any one embodiments 1-6, wherein the operations further comprise: determining, by the computer system, that there is no hash collision of the first data asset identifier with a plurality of identifiers stored in the security database prior to storing the first data asset identifier.
8. The medium of any one embodiments 1-7, wherein the operations further comprise: obtaining, by the computer system, the first data asset from a first data source.
9. The medium of embodiment 8, wherein the operations further comprise: storing, by the computer system, the first data source and a incrementing a first data asset count for the first data asset in the security database.
10. The medium of any one embodiments 1-9, wherein the first hashing algorithm and the second hashing algorithm are the same.
11. The medium of any one embodiments 1-10, wherein the operations further comprise: providing, by the computer system, an alert to a user associated with the first data asset.
12. The medium of any one embodiments 1-11, wherein the operations further comprise: flagging one or more user accounts associated with the first data asset determined from the first plurality of files.
13. The medium of any one embodiments 1-12, wherein the operations further comprise: parsing, by the computer system, the first data asset.
14. The medium of any one embodiments 1-13, wherein the operations further comprise steps for cleansing the first data asset.
15. The medium of any one embodiments 1-14, wherein the operations further comprise: normalizing, by the computer system, the first data asset.
16. The medium of embodiment 15, wherein the operations further comprise steps for normalizing the first data asset.
17. The medium of any one embodiments 1-16, wherein the first data asset includes a log.
18. The medium of any one embodiments 1-17, wherein the first hashing algorithm includes a secure hashing algorithm (SHA)-256 algorithm.
19. The medium of any one embodiments 1-18, wherein the operations further comprise steps for populating the security database.
20. A method comprising: the operations of any one of embodiments 1-19.
21. A system, comprising: one or more processors; and memory storing instructions that when executed by the processors cause the processors to effectuate operations comprising: the operations of any one of embodiments 1-19.

What is claimed is:

1. A non-transitory, machine-readable medium storing instructions that, when executed by one or more processors, effectuate operations comprising:
individually hashing, by a computer system and according to a first hashing algorithm, each file of a first plurality of files included in a first data asset to obtain a first plurality of hash values;
sorting, by the computer system and according to a sorting algorithm, each hash value of the first plurality of hash values in a first ordered list of hash values;
concatenating, by the computer system, the first plurality of hash values in the first ordered list of hash values to generate a first string;
hashing, by the computer system and according to a second hashing algorithm, the first string to generate a first data asset identifier representing the first data asset; and
storing, by the computer system, the first data asset identifier in a security database.

2. The medium of claim 1, wherein the operations further comprise:
storing, by the computer system, the first data asset in the security database.

3. The medium of claim 1, wherein the operations further comprise:
individually hashing, by the computer system and according to the first hashing algorithm, each file of a second plurality of files included in a second data asset to obtain a second plurality of hash values;
sorting, by the computer system and according to the sorting algorithm, each hash value of the second plurality of hash values in a second ordered list of hash values;
concatenating, by the computer system, the second plurality of hash values to generate a second string;
hashing, by the computer system and according to the second hashing algorithm, the second string to generate a second data asset identifier representing the second data asset; and
comparing, by the computer system, the first data asset identifier to the second data asset identifier to determine whether a hash collision has occurred.

4. The medium of claim 3, wherein the operations further comprise:
discarding, by the computer system, the second data asset if a hash collision occurred.

5. The medium of claim 4, wherein the operations further comprise:
determining, by the computer system, that a second source of the second data asset is different than a first source of the first data asset; and
logging, by the computer system, the second source with the first source in a data asset tracking library.

6. The medium of claim 3, wherein the operations further comprise:
not providing, by the computer system, an alert of the second data asset to a user associated with the second data asset if a hash collision occurred.

7. The medium of claim 1, wherein the operations further comprise:
determining, by the computer system, that there is no hash collision of the first data asset identifier with a plurality of identifiers stored in the security database prior to storing the first data asset identifier.

8. The medium of claim 1, wherein the operations further comprise:
obtaining, by the computer system, the first data asset from a first data source.

9. The medium of claim 8, wherein the operations further comprise:
storing, by the computer system, the first data source and a incrementing a first data asset count for the first data asset in the security database.

10. The medium of claim 1, wherein the first hashing algorithm and the second hashing algorithm are the same.

11. The medium of claim 1, wherein the operations further comprise:
providing, by the computer system, an alert to a user associated with the first data asset.

12. The medium of claim 1, wherein the operations further comprise:
flagging one or more user accounts associated with the first data asset determined from the first plurality of files.

13. The medium of claim 1, wherein the operations further comprise:
parsing, by the computer system, the first data asset.

14. The medium of claim 1, wherein the operations further comprise steps for cleansing the first data asset.

15. The medium of claim 1, wherein the operations further comprise:
normalizing, by the computer system, the first data asset.

16. The medium of claim 15, wherein the operations further comprise steps for normalizing the first data asset.

17. The medium of claim 1, wherein the first data asset includes a log.

18. The medium of claim 1, wherein the first hashing algorithm includes a secure hashing algorithm (SHA)-256 algorithm.

19. The medium of claim 1, wherein the operations further comprise steps for populating the security database.

20. A method comprising:
individually hashing, by a computer system and according to a first hashing algorithm, each file of a first plurality of files included in a first data asset to obtain a first plurality of hash values;
sorting, by the computer system and according to a sorting algorithm, each hash value of the first plurality of hash values in a first ordered list of hash values;
concatenating, by the computer system, the first plurality of hash values in the first ordered list of hash values to generate a first string;
hashing, by the computer system and according to a second hashing algorithm, the first string to generate a first data asset identifier representing the first data asset; and
storing, by the computer system, the first data asset identifier in a security database.
